(19) United States
(12) Patent Application Publication
(10) Pub. No.: US 2023/0315131 A1
(43) Pub. Date: Oct. 5, 2023

(54) MOBILE OBJECT AND CONTROL METHOD THEREFOR

(71) Applicant: HONDA MOTOR CO., LTD., Tokyo (JP)

(72) Inventors: Yuji YASUI, Wako-shi (JP); Misa KOMURO, Wako-shi (JP); Yutaka NISHIZAKI, Tokyo (JP)

(21) Appl. No.: 18/187,861

(22) Filed: Mar. 22, 2023

(30) Foreign Application Priority Data
Mar. 31, 2022 (JP) 2022-060614

(51) Int. Cl. G05D 1/12; G05D 1/02; G05D 1/00

(52) U.S. Cl. CPC G05D 1/12; G05D 1/0212; G05D 1/0088; G05D 1/0297

(57) ABSTRACT

A mobile object including a first sensor configured to detect a target object in surroundings, recognizes and sets a user; acquires a predicted path indicating a future path of the user that has been set, based on a movement of the user and an output from the first sensor, and generates a path of the mobile object to lead the user on a forward side of the user, based on the predicted path; and causes the mobile object to travel in accordance with the path that has been generated, and upon detection of a change in a moving direction of the user, based on the output from the first sensor, modifies the generated path to cause the mobile object to move to the forward side of the user in accordance with the moving direction that has been changed.

### CROSS-REFERENCE TO RELATED APPLICATION(S)

This application claims priority to and the benefit of Japanese Patent Application No. 2022-060614 filed on Mar. 31, 2022, the entire disclosure of which is incorporated herein by reference.

### BACKGROUND OF THE INVENTION

### Field of the Invention

The present invention relates to a mobile object and a control method therefor.

### Description of the Related Art

Autonomous mobile bodies are known, such as compact mobility vehicles or robots, each of which travels in the vicinity of a user to guide the user to a destination or carries baggage for the user. International Publication No. 2017/115548 proposes a mobile object that moves to travel to an appropriate position for a user, based on information of user's trunk and legs. In addition, Japanese Patent Laid-Open No. 2021-22108 proposes, regarding a mobile object deployed in an airport, a technique of leading a user while maintaining a certain distance to the user, and reducing a possibility that the user cannot reach a designated place by a boarding time.

### SUMMARY OF THE INVENTION

The user, by the way, does not always move along an assumed path, and there is a sufficient possibility that the user suddenly changes the path. When the user deviates a predicted path, there is a possibility of losing sight of the user (“lost”) due to an obstacle or the like. In a case where the user has been lost, it is difficult to search for a predetermined user from the mobile object. Hence, it is important to promptly determine such a path change that has been made by the user, and it is also important to modify the path of the mobile object in accordance with the path change that has been made by the user.

An object of the present invention is to provide a mobile object that suitably modifies a path in accordance with a path change that has been made by a user. In addition, another object is to suitably conduct re-authentication of the user, when the user has been lost by the mobile object.

According to one aspect of the present invention, there is provided a mobile object comprising: a first sensor configured to detect a target object in surroundings; a setting unit configured to recognize and set a user; a path generation unit configured to acquire a predicted path indicating a future path of the user, based on a movement of the user that has been set by the setting unit and an output from the first sensor, and configured to generate a path of the mobile object to lead the user on a forward side of the user, based on the predicted path; and a travel control unit configured to cause the mobile object to travel in accordance with the path that has been generated, wherein upon detection of a change in a moving direction of the user, based on the output from the first sensor, the path generation unit modifies the generated path to cause the mobile object to move to the forward side of the user in accordance with the moving direction that has been changed.

According to another aspect of the present invention, there is provided a control method for a mobile object including a first sensor configured to detect a target object in surroundings, the control method comprising: a setting step of recognizing and setting a user; a path generation step of acquiring a predicted path indicating a future path of the user that has been set in the setting step, based on a movement of the user and an output from the first sensor, and generating a path of the mobile object to lead the user on a forward side of the user, based on the predicted path; and a travel control step of causing the mobile object to travel in accordance with the path that has been generated, wherein upon detection of a change in a moving direction of the user, based on the output from the first sensor, the path generation step modifies the generated path to cause the mobile object to move to the forward side of the user in accordance with the moving direction that has been changed.

Further features of the present invention will become apparent from the following description of exemplary embodiments (with reference to the attached drawings).

### BRIEF DESCRIPTION OF THE DRAWINGS

FIG. 1 is a diagram illustrating a configuration example of a system;

FIGS. 2A and 2B are diagrams each illustrating a configuration example of a mobile object;

FIG. 3 is a diagram illustrating an example of a detailed configuration of the present system;

FIG. 4 is a diagram for describing a drive mode of the mobile object;

FIG. 5 is a diagram illustrating an overview of services of the present system;

FIG. 6 is a flowchart illustrating a processing procedure for controlling a path of the mobile object;

FIG. 7 is a flowchart illustrating a processing procedure for generating the path of the mobile object;

FIGS. 8A to 8D are diagrams each illustrating a movement pattern, when the user changes the path;

FIG. 9 is a diagram illustrating a state in which the path of the mobile object is changed in accordance with a path change that has been made by the user;

FIG. 10 is a flowchart illustrating a processing procedure for predicting a user path;

FIGS. 11A and 11B are diagrams each illustrating a pattern in which the user has been lost; and

FIG. 12 is a flowchart illustrating a processing procedure of control for tracking the user.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### Configuration Example of System

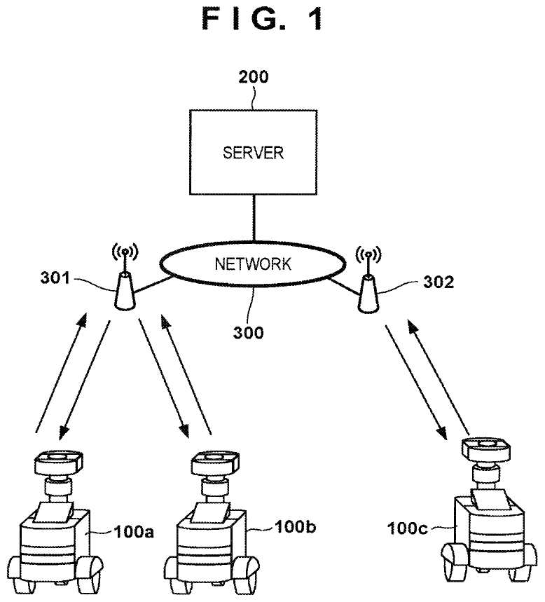

FIG. 1 illustrates a configuration example of a system including a mobile object and a server according to an embodiment of the present invention. The system includes mobile bodies 100a, 100b, and 100c, and a server 200. Since the mobile bodies 100a, 100b, and 100c have similar configurations, alphabets at the ends of reference numerals will be omitted in the following description. Note that in a case where a specific mobile object is described, its alphabet will be added to the end of the reference numeral.

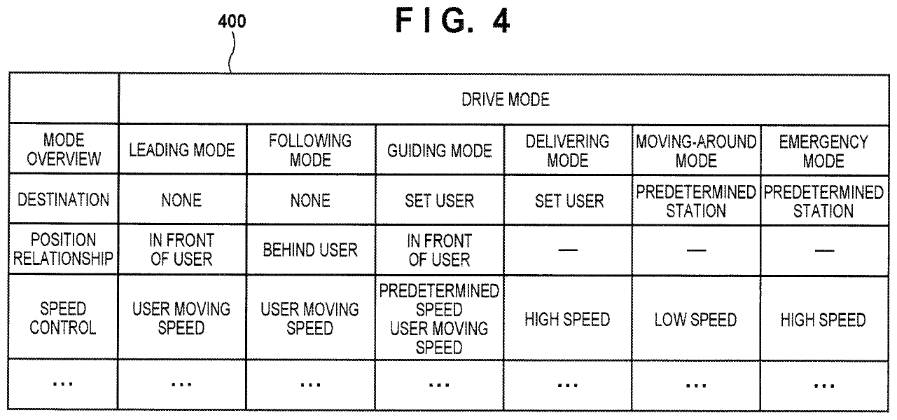

The mobile bodies 100 are arranged in various facilities such as shopping malls, parks, stations, airports, and parking lots, and provides various services to users that have been set (hereinafter, each of such users will be referred to as a “set user”). For example, the mobile object 100 is capable of leading, following, and guiding the set user to be supported, and is capable of making a delivery in response to a request of an authenticated user who has been registered beforehand. The service provided by the mobile object 100 can be changed in accordance with a drive mode of the mobile object, and the drive mode will be described later with reference to FIG. 4. Note that the set user indicates a user whose user confirmation has been conducted by a vein sensor, to be described later, provided in the mobile object 100. In addition, there is no intention of limiting the mobile object in the present invention to the mobile object illustrated in FIG. 1. The present invention is applicable to various mobile bodies, such as four-wheeled vehicles, two-wheeled vehicles, compact mobility vehicles, and robots.

The server 200 monitors a plurality of mobile bodies 100, causes the mobile bodies to move to the respective areas to enhance convenience of users, and controls their arranged positions and the like. Specifically, the server 200 causes the plurality of mobile bodies 100 to move to locations where the probability that the mobile bodies to be used is higher in areas of a building or the like in which the plurality of mobile bodies 100 are arranged. For example, control is conducted such that the mobile object is caused to move to the vicinity of the location where a crowd of people are present, and the number of mobile bodies 100 in the area is increased in accordance with the degree of the crowd. In addition, in registering a user, the server 200 may acquire information such as veins from the mobile object 100, and may register and authenticate the user. Note that whether the authentication via the server 200 is necessary may be determined separately in accordance with the drive mode of the mobile object 100 used by the user. For example, in a case of using in a delivering mode, only the user that has been registered beforehand via the server 200 may be authenticated. On the other hand, in leading, following, and guiding modes, users do not have to be registered beforehand. A user may be allowed to use only by setting the user itself with the mobile object 100. Identification information that has been acquired (vein information, feature information by use of a captured image, and the like) is used for confirmation processing (re-authentication), when, for example, the user and the mobile object 100 are separated from each other by a predetermined distance or more, that is, when the user has been lost and then the user is rejoined.

The mobile object 100 and the server 200 are capable of communicating bidirectionally through a network 300. More specifically, the mobile object 100 accesses the network 300 via an access point 301 or 302 in the vicinity, and becomes capable of bidirectionally communicating with the server 200 through the network 300. For example, in a case where the mobile object 100 is installed in a building such as a shopping mall or in its site, the server 200 is capable of identifying a rough position of the mobile object 100 by use of the access point 301 or 302 that has been accessed by the mobile object 100. That is, the access points 301 and 302 each have position information of the place where it is installed, and it is possible to identify a rough position of the mobile object 100 in accordance with the position information. Further, according to the position information of the access point, it is possible to easily recognize on which floor in the building the mobile object 100 is located (altitude information). Furthermore, the server 200 is capable of identifying a detailed position by use of position information output from a GNSS, to be described later, or the like and provided in the mobile object 100. In addition, by combining these pieces of information, the server 200 is capable of acquiring position information of the mobile object 100, which is an object, and which is located in the vicinity of an elevator of an underground parking lot, for example. When the position information output from the GNSS includes altitude information, the altitude information may be used, instead of the position information of the access point.

### Configuration of Mobile Object

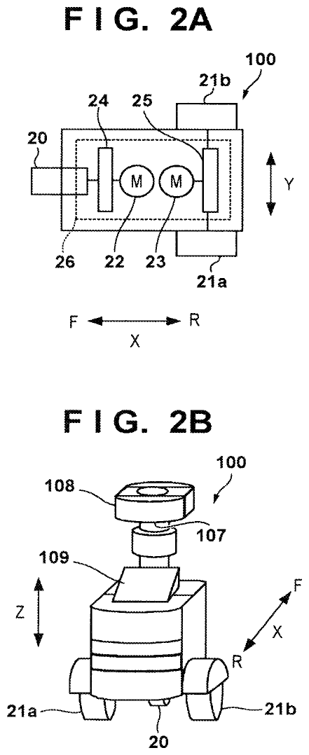

Next, a configuration example of the mobile object 100 according to the present embodiment will be described with reference to FIGS. 2A and 2B. FIG. 2A illustrates an internal configuration of the mobile object 100, and FIG. 2B illustrates a back surface of the mobile object 100 according to the present embodiment. In the drawing, an arrow X indicates a front-and-rear direction of the mobile object 100, and F indicates the front, and R indicates the rear. Arrows Y and Z respectively indicate a width direction (a left-and-right direction) and a vertical direction of the mobile object 100. Since the mobile bodies 100a, 100b, and 100c have similar configurations, alphabets at the ends of reference numerals will be omitted in the following description.

As illustrated in FIG. 2A, the mobile object 100 includes, as a traveling unit, a front wheel 20, rear wheels 21a and 21b, motors 22 and 23, a steering mechanism 24, a drive mechanism 25, and a housing unit 26. The steering mechanism 24 is a mechanism that changes the steering angle of the front wheel 20 with the motor 22 used as a drive source. By changing the steering angle of the front wheel 20, it is possible to change the advancing direction of the mobile object 100. The drive mechanism 25 is a mechanism that rotates the pair of rear wheels 21a and 21b with the motor 23 used as a drive source. By rotating the pair of rear wheels 21a and 21b, it is possible to cause the mobile object 100 to move forward or backward.

In addition, the mobile object 100 is an electrically autonomous mobile object with a battery 106, to be described later, used as a main power supply. The traveling unit corresponds to a three-wheeled vehicle including the front wheel 20 and the pair of left and right rear wheels 21a and 21b. The traveling unit may be in another form, such as a four-wheeled vehicle. In addition, a seat, not illustrated, can be provided in the mobile object 100.

The housing unit 26 indicates a space in which user's baggage or the like can be loaded. When vein authentication is conducted by a vein sensor 107, to be described later, and the user setting is conducted, the lock of a door (not illustrated) of the housing unit 26 is released, and the user is able to load the baggage. Then, after a predetermined time elapses or when the set user moves away from the mobile object 100, the door is locked. By conducting the vein authentication for the user again, it is possible to unlock the door. Therefore, the vein information of the set user is held in a memory or the like provided in the mobile object 100.

As illustrated in FIG. 2B, the mobile object 100 further includes the vein sensor 107, a detection unit 108, and an operation panel 109. The vein sensor 107 is a sensor that is provided to face downward below the detection unit 108, and detects the vein of the user's hand inserted into its detection range. By inserting the user's hand into below the vein sensor 107, the user is able to make user settings with the mobile object 100. By notifying the server 200 of the vein information of the set user that has been acquired by the vein sensor 107, it is also possible to conduct user registration. The user that has been registered as a user in the server 200 is able to use more drive modes of the mobile object 100.

The detection unit 108 is a 360-degree camera, and is capable of acquiring an image of 360 degrees in the horizontal direction at a time with the mobile object 100 as the center. Note that there is no intention of limiting the present embodiment, but for example, a camera, in which the detection unit 108 is provided to be rotatable in the horizontal direction, and images captured in a plurality of directions are combined to acquire an image of 360 degrees, may be adopted. As another configuration, a plurality of detection units may be provided to capture images in respectively different directions and analyze individual images. By analyzing a 360-degree image that has been captured by the detection unit 108, the mobile object 100 is capable of detecting a target object, such as a human or an object in the surroundings of the mobile object 100.

The operation panel 109 is a liquid crystal display of a touch panel type having a display unit and an operation unit. In the present invention, the display unit and the operation unit may be configured to be provided individually. The operation panel 109 displays various types of information such as a setting screen for setting the drive mode of the mobile object 100 and map information for giving current position information and the like to the user.

### Detailed Configuration of System

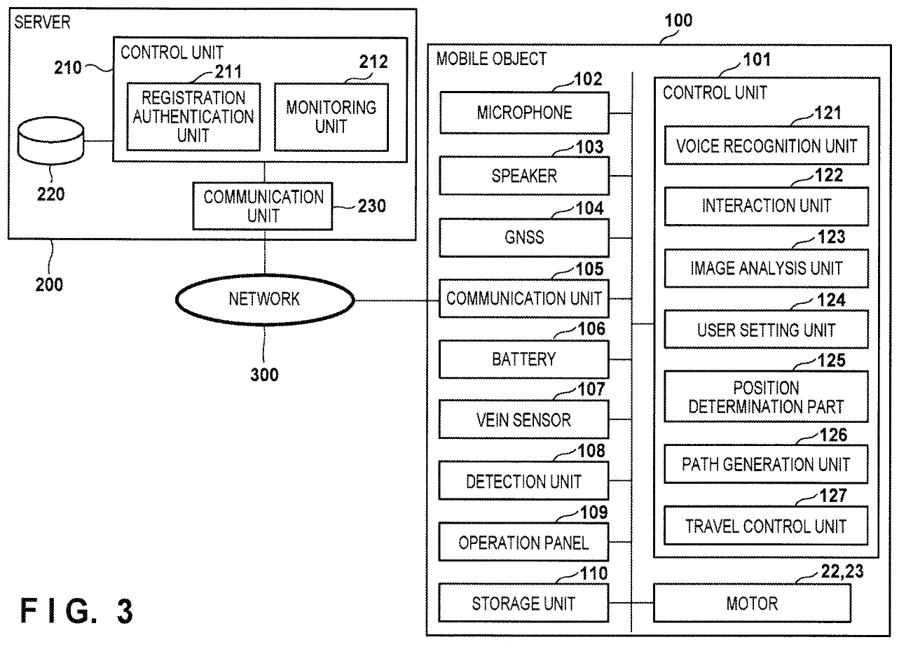

A detailed configuration of each apparatus included in the present system will be described with reference to FIG. 3. Here, a configuration of each apparatus will be described, but the configuration necessary for describing the present invention will be mainly described, and the descriptions of other configurations will be omitted. That is, the configuration of each apparatus in the present invention is not limited to the configuration to be described below, and an additional configuration or an alternative configuration is not excluded.

The server 200 serves as an information processing apparatus such as a personal computer, and includes a control unit 210, a storage unit 220, and a communication unit 230. The control unit 210 includes a registration authentication unit 211 and a monitoring unit 212. By reading and executing a control program stored in the storage unit 220, the control unit 210 achieves various processes. In addition to the above control program, the storage unit 220 stores various data, setting values, registration information of users, and the like. The registration information of users includes authentication information including vein information and feature information of the users. The communication unit 230 controls communication with the mobile object 100 through the network 300.

The registration authentication unit 211 registers users, and authenticates the users that have been registered beforehand. The user registration may be conducted via the mobile object 100, or may be conducted by another device, such as a smartphone or a PC. In a case where the user registration is conducted via the mobile object 100, the vein information that has been acquired as the authentication information by the vein sensor 107 and the feature information of the user that has been extracted from the image acquired by the detection unit 108 are registered in association with the identification information of the user. In addition, the authentication information may include information of a password that has been set by the user. For the identification information, a user's name, a registration number, or the like can be used.

The monitoring unit 212 monitors a plurality of mobile bodies 100 arranged in a predetermined area, and controls a standby position, a move-around area, and the like of the mobile object 100 in accordance with a situation of a facility or the like where the plurality of mobile bodies 100 are arranged. Regarding the situation of the facility where the plurality of mobile bodies 100 are arranged, for example, the degree of the crowd may be acquired by conducting an image analysis on a captured image from each mobile object 100. In such a case, for example, an image that has been captured by the mobile object 100 in a moving-around mode is transmitted to the server 200, and is used. The standby position is provided at a predetermined place, and denotes a position where the mobile object 100 with no user setting stops. Note that even in a case where the user setting has been made, it is possible to temporarily stop at the standby position. For example, when the set user enters a place where the mobile object 100 is not capable of entering together, the mobile object 100 can wait at a standby position in the vicinity until the set user conducts re-authentication. In addition, the move-around area indicates an area where the mobile object 100 with no user setting moves around in the moving-around mode to be described later. The monitoring unit 212 monitors the positions of the plurality of mobile bodies 100, and for example, causes the mobile object 100 waiting on standby in the vicinity of a place where there are not many people to move to the vicinity of a place where many people are gathered. Accordingly, a more highly convenient system can be provided. Further, the monitoring unit 212 may grasp the battery remaining amount of each mobile object 100, and may plan a schedule for charging each mobile object 100 for efficient charging at a charging station.

The mobile object 100 includes a control unit 101, a microphone 102, a speaker 103, a GNSS 104, a communication unit 105, a battery 106, and a storage unit 110, in addition to the configuration described with reference to FIGS. 2A and 2B. These components, the motors 22 and 23, the vein sensor 107, the detection unit 108, and the operation panel 109 are connected to be capable of transmitting signals to one another through a system bus or the like. Note that in the following description, the descriptions for the components that has been already described with reference to FIGS. 2A and 2B will be omitted.

The control unit 101, such as an electronic control unit (ECU), controls each device connected by a signal line. By reading and executing a program stored in the storage unit 110, the control unit 101 performs various processes. In addition to the control program, the storage unit 110 includes an area for storing various data, setting values, and the like, and a work area for the control unit 101. Note that the storage unit 110 does not have to be configured with a single device, and can be configured to include at least one of memory devices that are ROM, RAM, HDD, and SDD, for example.

The operation panel 109 denotes a device including an operation unit and a display unit, and may be achieved by, for example, a liquid crystal display of a touch panel type. In addition, the operation unit and the display unit may be individually provided. Various operation screens, map information, notification information to the user, inquiry information, and the like are displayed on the operation panel 109. Further, in addition to the operation panel 109, the mobile object 100 is capable of interacting with the user via the microphone 102 and the speaker 103.

A global navigation satellite system (GNSS) 104 receives a GNSS signal, and detects the current position of the mobile object 100. The communication unit 105 accesses the network 300 through the access point 301 or 302, and bidirectionally communicates with the server 200, which is an external apparatus. The battery 106 is, for example, a secondary battery such as a lithium ion battery, and the mobile object 100 is capable of traveling by itself on the above traveling unit with electric power supplied from the battery 106. In addition, the electric power from the battery 106 is supplied to each load.

A control configuration of the control unit 101 will be described. The control unit 101 includes, as the control configuration, a voice recognition unit 121, an interaction unit 122, an image analysis unit 123, a user setting unit 124, a position determination unit 125, a path generation unit 126, and a travel control unit 127. The voice recognition unit 121 receives sounds in the surroundings of the mobile object 100 through the microphone 102, and recognizes and interprets, for example, a voice from the user. In interacting with the user by voice, the interaction unit 122 generates a question or an answer, and causes the question or the answer to be output by sounds of voice through the speaker 103. Note that regarding the interaction with the user, conversations of the user that has been subjected to voice recognition, and an answer, a question, a warning, and the like from the mobile object 100 may be displayed on the operation panel 109 in accordance with a voice output or voice recognition.

The image analysis unit 123 analyzes an image that has been captured by the 360-degree camera that is the detection unit 108. Specifically, the image analysis unit 123 recognizes a target object including a human or an object from the captured image, and analyzes the image to extract a feature of the user. The feature of the user includes, for example, various features such as a color of clothes, baggage, and a behavioral habit.

The user setting unit 124 sets a user who uses the mobile object 100. Specifically, the user setting unit 124 sets the user by storing the vein information of the user that has been acquired by the vein sensor 107, in the storage unit 110. In addition, the user setting unit 124 may store the feature information of the set user that has been extracted by the image analysis unit 123 in association with the above vein information. After the user is set by the user setting unit 124, the vein information and the feature information stored in the storage unit 110 are used for reconfirming (re-authenticating) the user, when the user has been lost or the like. Here, “lost” denotes that the mobile object 100 has lost sight of the set user for a predetermined time or more. When the user has been lost, the mobile object 100 moves to, for example, a place in the vicinity where the mobile object 100 can stop, temporarily stops, and waits on standby until the vein sensor 107 or the detection unit 108 confirms the set user.

The position determination unit 125 determines a position relative to the set user, as a position where the mobile object 100 travels. For example, in leading the user, the position determination unit 125 determines at which position relative to the set user the mobile object leads the set user in accordance with the information of the movement of the user and the surrounding environment. The leading position is desirably a position from which it is easy for the user to recognize the mobile object 100, and it is less likely to come into contact with an obstacle including anyone in the surroundings. Note that the leading position is basically determined to be a position on the predicted path of the user while maintaining a predetermined distance to the user.

The path generation unit 126 generates a path along which the mobile object 100 moves in accordance with the current drive mode of the mobile object 100. The generation of the path here is not a path to the destination but a path for a short distance, for example, five meters or so. Therefore, the path generation unit 126 repeatedly generates a path until the mobile object 100 reaches a destination or the user stops. In addition, when the user deviates from the path, the generated path is modified in accordance with a user's movement. Further, in the leading mode, the path generation unit 126 predicts a movement of the set user from an analysis result of the image analysis unit 123 that has analyzed the captured image of the detection unit 108, and obtains a predicted path indicating a future path of the user. Furthermore, the path generation unit 126 generates a path of the mobile object so as to lead the user on a forward side of the user, based on the predicted path that has been obtained. Details of path generation will be described later.

The travel control unit 127 controls traveling of the mobile object 100 to maintain the leading position and the path in accordance with the path that has been generated by the path generation unit 126. Specifically, the travel control unit 127 causes the mobile object 100 to move along the generated path, and controls its movement while adjusting the positional relationship with the set user by use of the captured image of the detection unit 108. For example, when the distance becomes a predetermined distance or more, the speed is decreased, or when the set user is deviated to the left side from the path, the mobile object 100 similarly moves to the left side to maintain the leading position. On the other hand, when it is determined that the path has been changed, the path is regenerated (modified).

### Drive Mode

Next, a drive mode of the mobile object 100 according to the present embodiment will be described with reference to FIG. 4. A table 400 indicated in FIG. 4 illustrates drive modes of the mobile object 100 and features of them. The drive modes to be described below are examples, and there is no intention of excluding any other drive modes.

The mobile object 100 includes, as the drive modes, for example, at least one of a leading mode, a following mode, a guiding mode, a delivering mode, a moving-around mode, and an emergency mode. The leading mode is a mode in which the mobile object 100 is controlled to travel on a forward side of the user in accordance with a moving speed of the user, in a state in which no destination is set. The following mode is a mode in which the mobile object 100 is controlled to travel on a rearward side of the user in accordance with a moving speed of the user in a state in which no destination is set. The guiding mode is a mode in which the mobile object 100 is controlled to travel in accordance with a predetermined speed or a moving speed of the user on a forward side of the user toward a destination in a state in which the destination is set by the user.

The delivering mode is a mode in which the mobile object 100 is controlled to travel at high speed toward a destination in a state in which the destination is set by the user. In addition, the delivering mode is a mode in which any package is loaded on the housing unit 26 so as to be delivered to the destination. The moving-around mode is a mode in which the mobile object 100 is controlled to travel at low speed for heading for a predetermined station (a standby station or a charging station) as a destination. In addition, in the moving-around mode, no user is set, and it is a mode of searching for a user. In the moving-around mode, the mobile object 100 travels while monitoring the surrounding environment by the detection unit 108. For example, upon detection of a human approaching the mobile object 100 while raising its hand, the mobile object 100 determines that such a human is a user who desires to use the mobile object 100, moves to a forward side of the user, and then stops. The emergency mode is a mode for controlling the mobile object 100 to travel at high speed for heading for a predetermined station as a destination. The emergency mode is conducted, for example, to cause the mobile object 100 to move to a charging station when the charge amount of the battery 106 becomes lower than a predetermined value, or to deliver a package to a lost-and-found station that stores lost articles when the set user forgets the package.

### Operation Overview of Present System

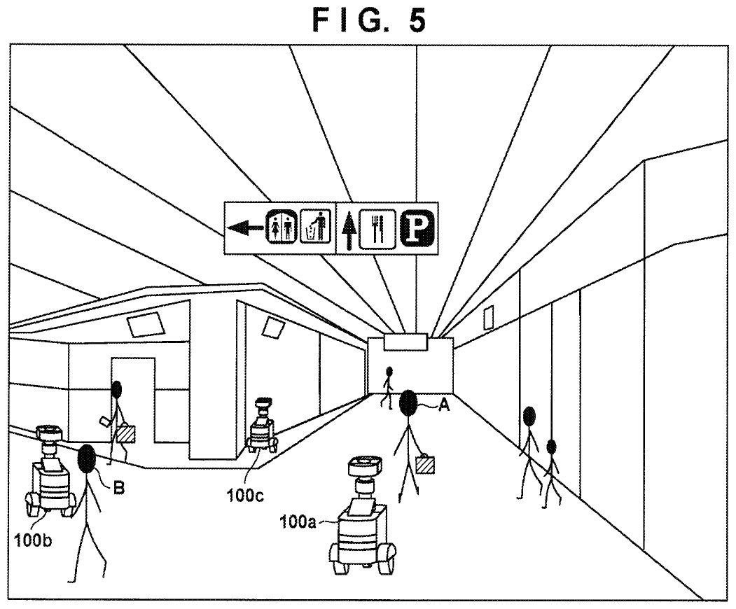

Next, an operation overview of the present system will be described with reference to FIG. 5. The plurality of mobile bodies 100 managed by the server 200 are arranged in various facilities, such as shopping malls, parks, stations, airports, and parking lots. Here, a case where the plurality of mobile bodies 100 are arranged in a shopping mall will be described as an example. In the shopping mall, for example, there are various sites, such as a parking lot, a shop, a restaurant, and a restroom. In addition, according to the present system, stations are also installed, such as a standby station where the mobile object 100 waits on standby, a charging station for charging the mobile object 100, and a lost-and-found station to which a lost article of the user who used the mobile object 100 is delivered. In the present system, in such a facility, various services are provided for the user by the drive modes of the mobile object 100.

For example, as illustrated in FIG. 5, the mobile object 100a provides a set user A with a following service. In addition, the mobile object 100b provides a set user B with a leading service. The mobile object 100c temporarily stops to wait on standby for a set user, not illustrated, who has entered a shop in the vicinity. For example, the mobile object 100 includes map information of the shopping mall in the storage unit 110, and waits on standby at any place in the vicinity, when the set user enters an entry prohibited range that is set in the map information.

Note that, in such a facility, the user gets interested in a shop, a product, or the like that is visually recognized, and thus, the user may suddenly change the path, in many cases. In such cases, for example, there is a high possibility that the mobile object 100b will lose sight of the user B, who is a target for leading and is subject to tracking (“tracking”)(“lost”)mobile object. In addition, there are many objects such as people and walls that obstruct the tracking of the set user. For example, someone who cuts across between the mobile object 100 and the set user, or an object such as a wall of a corner when the mobile object 100 turns the corner may become an obstacle for the detection unit 108 to catch sight of the set user. Hereinafter, a service in the leading mode from among various services provided by the present system will be described.

### Processing Flow

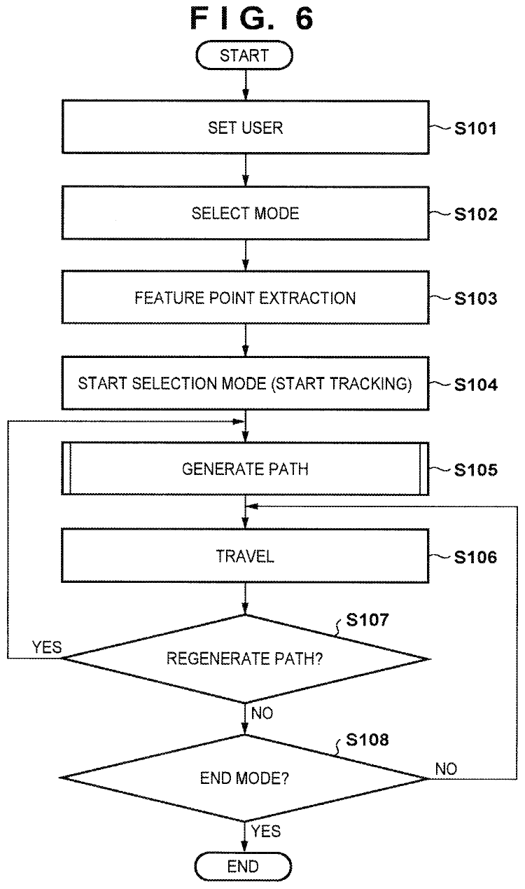

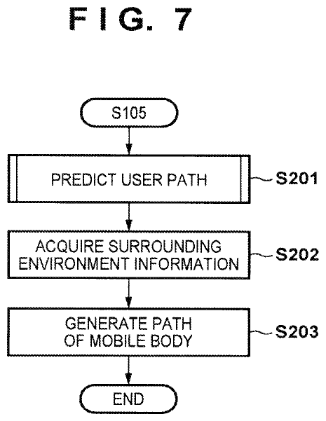

In the following description, a basic processing flow of the leading mode in the mobile object according to the present embodiment will be described with reference to FIGS. 6 and 7.

### Leading Mode

First, a processing procedure in the leading mode of the mobile object 100 according to the present embodiment will be described with reference to FIG. 6. The processing to be described below is achieved by the CPU of the control unit 101 reading the control program stored in the storage unit 110 into the RAM and executing the control program.

First, in S101, the control unit 101 sets a user. In the mobile object 100 in which no user who is moving around or who stops is set, the detection unit 108 conducts an image analysis on a surrounding environment when needed. In such a situation, for example, upon detection of a human approaching the mobile object 100 while raising its hand, the control unit 101 causes the travel control unit 127 to approach such a human to be a target and then stop the mobile object 100. Then, when such a human inserts its hand into the detection range of the vein sensor 107, the vein information is acquired. The control unit 101 causes the user setting unit 124 to store the acquired vein information in the storage unit 110 and to set the user as a set user.

Subsequently, in S102, the control unit 101 displays a mode selection screen on the operation panel 109 to prompt the set user to select the drive mode of the mobile object 100. In addition, in S103, the control unit 101 causes the detection unit 108 to capture an image of the set user, and causes the image analysis unit 123 to extract a feature point of the user. The extracted features include various features, for example, a color of clothes, baggage, a behavioral habit, and the like. These features are always used for recognizing the user, in the case of leading the user or the like. Note that S102 and S103 do not have to be performed in this processing order, and may be performed in the reverse order or may be performed in parallel.

Next, in S104, the control unit 101 starts movement control of the mobile object 100 in the drive mode that has been selected by the user via the mode selection screen displayed on the operation panel 109. In the present embodiment, a case where the leading mode is selected will be described. When the movement control in the leading mode is started, the control unit 101 starts monitoring the movement of the set user in accordance with an analysis result of the image analysis unit 123 that has analyzed a captured image. Specifically, the control unit 101 monitors at least a current position and an orientation of the user, and predicts subsequent moving direction and moving speed of the user. The current position may be acquired, for example, as a relative position by use of a distance from the mobile object 100. The orientation of the user is determined by, for example, the line of sight (face) and the orientation of the body (trunk). According to the present embodiment, the direction in which the user is predicted to move in the future is determined in accordance with the line of sight, and the current moving direction is determined in accordance with the trunk orientation. This is because a human does not always face or look at its moving direction, and the trunk is more likely to be directed in the moving direction than the face or the line of sight. On the other hand, there is a possibility that an object in which the user is interested may be present in the destination of the line of sight, and in such a case, its direction can become a future path of the user. Note that various methods may be used for a method, by the detection unit 108, for acquiring the direction of the line of sight from the captured image of the set user, without particularly limiting. For example, the determination may be made by the recognized positions of the pupil and the iris in an eye of the set user. In a case where the position of the pupil or the iris is not recognizable, it may be substituted by acquiring the orientation of the face. In addition, it is possible to acquire the moving speed of the user, based on the time-series data related to the current position of the user.

Next, in S105, the control unit 101 causes the position determination unit 125 and the path generation unit 126 to perform path generation processing of the mobile object 100. In the path generation processing, a predicted path indicating the future movement of the user is acquired, and a path indicating the moving route of the mobile object 100 is further generated. Details of the path generation processing will be described later with reference to FIG. 7. Subsequently, in S106, the control unit 101 causes the travel control unit 127 to control the traveling of the mobile object 100 in accordance with the path generated in S105. The travel control unit 127 controls the steering and speed of the mobile object 100 in accordance with the path. In addition, the travel control unit 127 controls the position of the mobile object 100 to maintain the distance between the set user and the mobile object 100 for a predetermined distance in accordance with tracking information of the set user in S401 to be described later.

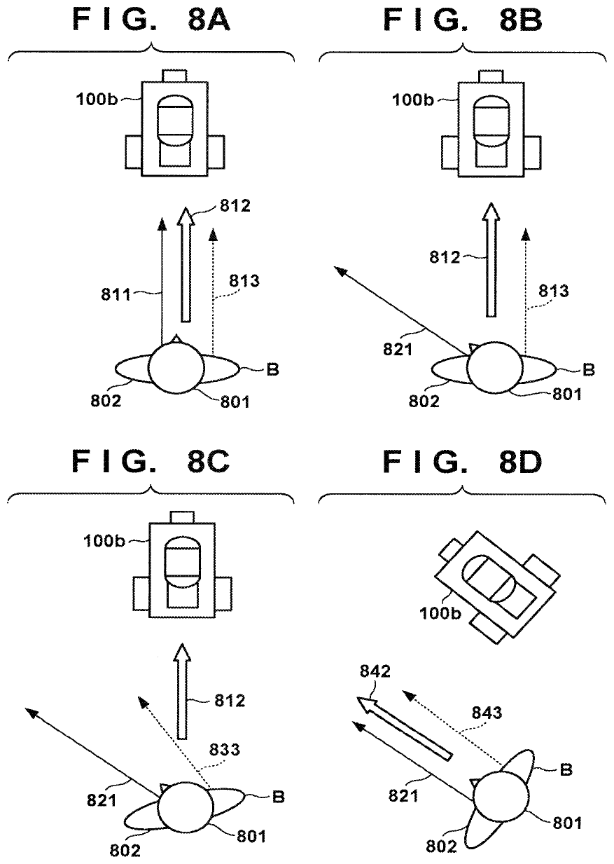

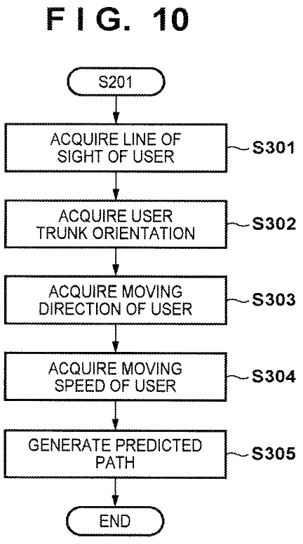

Next, in S107, the control unit 101 determines whether it is necessary to regenerate a path during traveling. In a case where it is determined that the path has to be regenerated, the processing returns to S105, and in the other cases, the processing proceeds to S108. Regarding the case where it is necessary to regenerate the path, two cases are included that are a case where a predetermined change or more in the moving direction of the user is detected within a predetermined time, and a case where the next path is generated when the user approaches within a predetermined distance of an end point of the path of the mobile object 100 generated in S105. Details of the above change in the moving direction of the user will be described later with reference to FIGS. 8A to 10. In S107, the control unit 101 detects a change in the moving direction of the user, based on processing results of S301 to S305 illustrated in FIG. 10 to be described later. In addition, when the set user moves away from the predicted path beyond a predetermined distance, the control unit 101 determines that the set user deviates from the predicted path.

In S108, the control unit 101 determines whether the current drive mode (here, the leading mode) has been ended by the set user. For example, the user is able to give an instruction to end the leading mode via the operation panel 109. In addition, the user is able to give an instruction to end the leading mode by voice via the microphone 102. In a case where it is determined that the mode has been ended, the processing of the present flowchart is ended, and in the other cases, the processing returns to S106.

### Path Generation Processing

Subsequently, a detailed processing procedure of the path generation processing (S105) in the leading mode of the mobile object 100 according to the present embodiment will be described with reference to FIG. 7. The processing to be described below is achieved by the CPU of the control unit 101 reading the control program stored in the storage unit 110 into the RAM and executing the control program.

First, in S201, the control unit 101 acquires a future movement (predicted path) of the set user from the image that has been captured by the detection unit 108. A specific method for acquiring the predicted path will be described later with reference to FIGS. 8A to 10. Subsequently, in S202, the control unit 101 acquires surrounding environment information from the image that has been captured by the detection unit 108. The surrounding environment information denotes information about the set user and a target object in the surroundings of the mobile object 100 included in the captured image. That is, the control unit 101 extracts a target object in a predetermined range in the surroundings from the captured image. In a case where the extracted target object involves a movement, the control unit also predicts the movement. The predetermined range is desirably, for example, an area on a forward side of the mobile object 100 that leads the set user. This is because a path is generated not to come into contact with a target object present on a forward side of the mobile object 100. For example, when the surrounding environment information is acquired for a human (target object) who is going to cross from right to left in a forward area, it is recognized that there is a possibility that the mobile object 100 comes into contact with the human who is crossing from right to left at a destination to which the mobile object will move in the future. Accordingly, a path is generated to avoid such contact.

Next, in S203, the control unit 101 generates the path of the mobile object 100, based on the predicted path of the set user and the surrounding environment information. Specifically, the control unit 101 generates the path of the mobile object 100 to travel through a location on a forward side by a predetermined distance from the set user in accordance with the predicted path acquired in S201 and not to come into contact with the target object that has been detected from the surrounding environment information acquired in S202. When the path is generated, the processing of the present flowchart is ended, and the processing proceeds to S106 of FIG. 6.

### Predicted Path

Next, a method for acquiring a predicted path of the user according to the present embodiment will be described with reference to FIGS. 8A to 10. First, a movement pattern when the user changes the path will be described with reference to FIGS. 8A to 8D. FIGS. 8A to 8D each illustrate a state in which the path is gradually changed, while the mobile object 100b is leading the user B.

FIG. 8A illustrates a state in which the mobile object 100b is leading the user B and the user B is moving facing the direction of the mobile object 100b. Reference numeral 801 denotes a state in which the head of the user B is viewed from above. Reference numeral 802 denotes a state in which the trunk of the user B is viewed from above. Reference numeral 811 denotes a line of sight of the user B. Reference numeral 812 denotes a moving direction of the user B. Reference numeral 813 denotes a trunk orientation of the user B. In the state of FIG. 8A, the line-of-sight direction 811, the trunk orientation 813, and the moving direction 812 are all directed in the same direction.

As described above, the line-of-sight direction of the user is acquired by detecting the positions of the pupil and the iris in an eye (for example, positions with respect to the inner corner of the eye) of the set user that has been recognized from the captured image of the user that has been captured by the detection unit 108. In addition, in a case where the position of the pupil or the iris is not recognizable, it may be substituted by acquiring the orientation of the face. As a method for estimating the orientation of the face, various image recognition algorithms can be used. For example, a method for normalizing a face by detecting a face attribute (eyes, nose, or mouth), a method for extracting a parallel vector and a rotation vector of the face, or the like can be used. Similarly, various image recognition algorithms can be used for the trunk orientation. Further, the moving direction of the user can be acquired, based on time-series data related to the current position of the user.

FIG. 8B illustrates a state in which while the user B is moving in the leading direction of the mobile object 100b, only the line-of-sight direction of the user B is directed in a different direction. The same components as those in FIG. 8A are denoted by the same reference numerals, and the descriptions will be omitted. In FIG. 8B, only a line-of-sight direction 821 is different from FIG. 8A, and the line-of-sight direction 821 of the user B is directed to an obliquely left front side. In this manner, in a case where only the line-of-sight direction is different from the trunk orientation and the moving direction, the user is merely looking at the direction in which the user is interested, and it is unclear whether the user will change the path in that direction. Therefore, basically, in the state of FIG. 8B, it is not concluded that the path will be changed. The path change is determined in the above S107. Note that although it depends on the processing performance of the mobile object 100, it is unclear whether the path will be changed at the time of FIG. 8B, but a predicted path with use of the line-of-sight direction may be generated as a candidate to prepare for a situation that the user will change the path to the line-of-sight direction. In this case, it is necessary to also generate a predicted path in accordance with the trunk orientation 813 and the moving direction 812.

FIG. 8C illustrates a state in which the user B is going to change the path while moving in the leading direction of the mobile object 100b. The same components as those in FIG. 8B are denoted by the same reference numerals, and the descriptions will be omitted. Here, it can be seen that a trunk orientation 833 of the user B is further approaching the line-of-sight direction 821 from the state of FIG. 8B. In this manner, the human usually directs the body in the direction to which the human is going to move, and in the state of FIG. 8C, the possibility that the path of the user B will be changed is increased. Therefore, in order to handle a sudden path change by the user, it is desirable to determine that the path will be changed in a state in which the trunk orientation also changes in accordance with the line-of-sight direction. Therefore, according to the present embodiment, although it depends on the processing performance of the mobile object 100, a candidate for the predicted path in accordance with the line-of-sight direction 821 is generated at this timing. Note that in this state, the user changes the orientation only for a moment, but the moving direction is not changed in fact. Therefore, there is a possibility that the orientation will return to the original one without a change of the moving direction. Therefore, since there is a possibility that the candidate of the predicted path that has been generated will not be used, the predicted path that is changed at this timing does not have to be generated, if the mobile object 100 does not have sufficient processing performance.

FIG. 8D illustrates a state in which the user B has changed the moving direction in accordance with the line-of-sight direction 821. The same components as those in FIG. 8C are denoted by the same reference numerals, and the descriptions will be omitted. A moving direction 842 of the user B has been changed to a direction similar to the line-of-sight direction 821, and illustrates a situation in which the user B is beginning to move in the direction that has been changed. Note that a trunk orientation 843 is also directed in the same direction as the line-of-sight direction 821, when compared with that of FIG. 8C. In this state, it can be seen that the user B has changed the path, and is beginning to move in the changed direction. Note that for facilitating the description, the line-of-sight direction 821, the moving direction 842, and the trunk orientation 843 are all illustrated to be directed in the same direction, but do not have to be directed in exactly the same direction. At this timing, the mobile object 100 determines in the above S107 that the user B has changed the moving direction, and modifies the path so as to move to a forward side of the user B and lead the user B, based on the predicted path that has been acquired. Note that in a case where the predicted path of the mobile object 100 has not been acquired so far depending on the processing performance of the mobile object 100, the predicted path of the user B is acquired here. Also here, the predicted path is generated in accordance with the line-of-sight direction 821.

According to the present embodiment, it is determined that the user will change the path at any of the timings in FIGS. 8B to 8D, and the predicted path is acquired. On the other hand, the case where the path of the mobile object 100 is actually modified in accordance with the predicted path is the case where the user B has actually changed the moving direction in FIG. 8D. At this timing, the path of the mobile object 100b is generated in accordance with the predicted path that has been already acquired. In this manner, by acquiring the predicted path of the user beforehand at the timing of FIG. 8B or 8C, it is possible to modify the path of the mobile object 100 smoothly, when the user actually changed the moving direction.

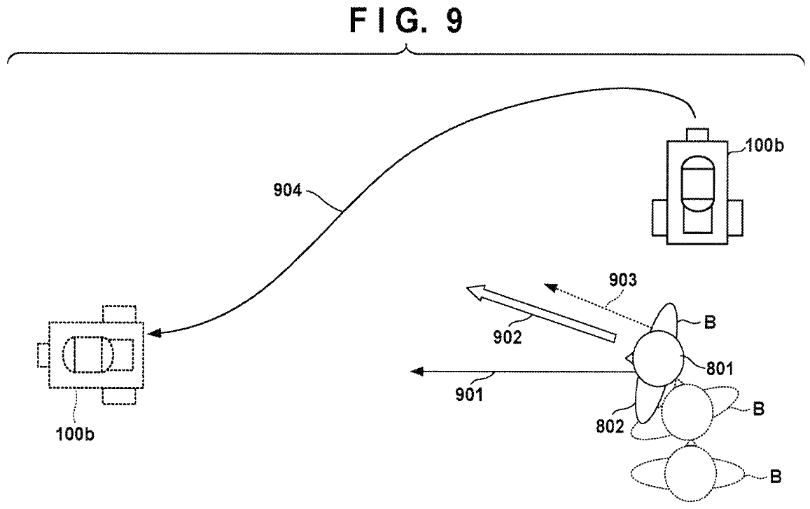

FIG. 9 illustrates a state in which the path of the mobile object 100 is modified by the path change that has been made by the user. Here, the user B changes the path by 90 degrees to the left direction, which is the line-of-sight direction 901, from the direction of the mobile object 100b that is leading the user B. At the timing illustrated in FIG. 9, the moving direction 902 of the user and a trunk orientation 903 are in a state of changing to a direction getting closer to the line-of-sight direction 901, but are not in the same direction. However, after the moving direction 902 and the trunk orientation 903 are directed in the same direction as the line-of-sight direction 901, if the predicted path is acquired and the path of the mobile object 100b is modified, it will be late for the movement of the user B and there is an increased possibility of losing the user B.

Hence, according to the present embodiment, when the moving direction changes by a predetermined amount or more within a predetermined time, it is determined that the user has changed the path, and the path of the mobile object 100b is also modified. In the example of FIG. 9, in a case where a predetermined change or more in the moving direction 902 is detected within a predetermined time (for example, in a case where there is a change of 30 degrees or more within two seconds, or the like), a path indicated by an arrow 904 is generated as the path of the mobile object 100b. Such a path is generated in accordance with the line-of-sight direction 901. By conducting the control in this manner, according to the present embodiment, the mobile object 100 can be positioned on a forward side of the user again in accordance with the predicted path of the user, without losing the user, even in a sudden path change that has been made by the user. Note that here, the path is modified to move to a forward side at a future position of the set user in accordance with the predicted path. However, when a change in the moving direction of the user is detected, the path may be firstly generated in a direction of shortening the distance from the user. By conducting the control in this manner, the possibility of losing the user can be reduced.

Subsequently, a detailed processing procedure of acquisition processing (S201) of the predicted path of the user according to the present embodiment will be described with reference to FIG. 10. The processing to be described below is achieved by the CPU of the control unit 101 reading the control program stored in the storage unit 110 into the RAM and executing the control program.

First, in S301, the control unit 101 causes the image analysis unit 123 to acquire the line of sight of the user from the captured image of the set user that has been captured by the detection unit 108. Subsequently, in S302, the control unit 101 causes the image analysis unit 123 to acquire the trunk orientation of the user from the captured image of the set user that has been captured by the detection unit 108.

Subsequently, in S303, the control unit 101 causes the image analysis unit 123 to acquire the position of the user at each timing from the time-series data of the captured image of the set user that has been captured by the detection unit 108, and acquires the moving direction of the user. Similarly, in S304, the control unit 101 acquires the moving speed of the user, based on the user position at each timing in the time-series data acquired in S303.

Finally, in S305, the control unit 101 generates a predicted path of the user in accordance with the information acquired in S301 to S304, ends the processing of the present flowchart, and the processing proceeds to S202. Although the direction of the predicted path that has been generated desirably follows the line-of-sight direction, there is no intention of limiting the present invention. For example, in addition to the line-of-sight direction, the trunk orientation and the current moving direction of the user may be considered. For example, in a case where the moving direction of the user and the trunk orientation are substantially the same, it is determined that there is no further path change, and the moving direction and the trunk orientation may be set as the direction of the predicted path. Alternatively, an intermediate direction between the line-of-sight direction and the moving direction of the user may be set as the direction of the predicted path. In addition, in a case where the line-of-sight direction cannot be acquired, the direction of the predicted path may be determined by use of only the moving direction and the trunk orientation.

### Tracking Control (Tracking)

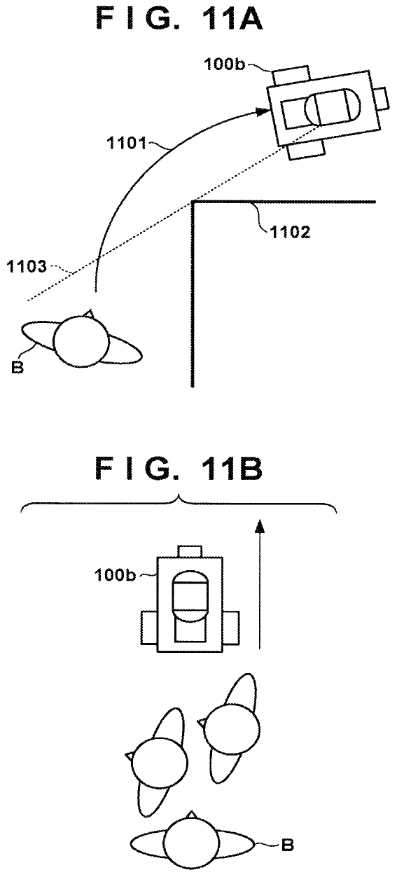

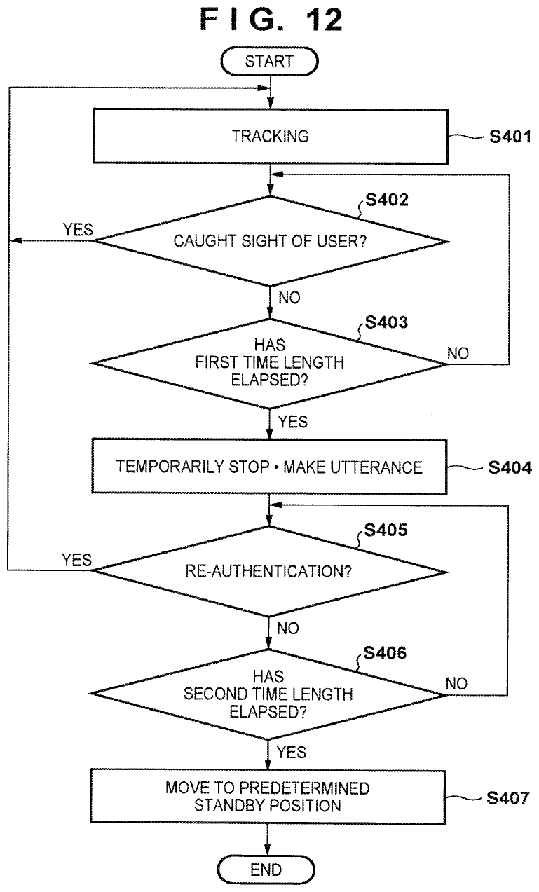

Next, tracking control according to the present embodiment will be described with reference to FIGS. 11A to 12. The mobile object 100 provides a service while tracking the set user, in the leading mode, the following mode, and the guiding mode. Here, control for tracking the set user, in particular, control of a case of losing sight of the user during tracking will be described. First, a pattern in which the mobile object 100 loses the user will be described with reference to FIGS. 11A and 11B.

FIG. 11A illustrates a state in which the mobile object 100b leading the user B turns to the right along a path 1101. At such a corner, there is a possibility that, for example, a wall 1102 makes the user B enter a dead angle of the detection unit 108. Reference numeral 1103 denotes a boundary of an imaging range of the detection unit 108, and the user B is located outside the boundary. Therefore, the user B is not included in the captured image of the detection unit 108, the mobile object 100b is not capable of tracking the user B, and the mobile object 100b loses sight of the user B even though it is temporary.

FIG. 11B illustrates a state in which humans cut across between the mobile object 100b that is leading the user B and the user B. In such a case, although the user B is included in the imaging range of the detection unit 108 of the mobile object 100b, a passerby who is passing between the user B and the mobile object 100b becomes an obstacle, and the user B is not included in a captured image from which it is enough to be capable of extracting the feature of the user B. Hence, even in such a case, the mobile object 100b is not capable of tracking the user B, and the mobile object 100b loses sight of the user B, even though it is temporary.

Subsequently, a processing procedure of the tracking control according to the present embodiment will be described with reference to FIG. 12. Note that the present flowchart is performed at a timing when the leading mode is selected and started in S104. The processing to be described below is achieved by the CPU of the control unit 101 reading the control program stored in the storage unit 110 into the RAM and executing the control program.

First, in S401, the control unit 101 tracks (tracking) the set user in the captured image that has been captured by the detection unit 108, by use of the feature point of the user acquired in S103. The tracking information acquired here is also used for travel control of the mobile object 100 in the above S106. Subsequently, in S402, the control unit 101 determines whether the tracking in S401 caught sight of the user. In a case where the tracking caught sight of the user, the processing returns to S401, and continues tracking. On the other hand, in a case where the tracking caught sight of the set user, and in a case where the set user is not included in the captured image, for example, as illustrated in FIG. 11A or 11B, the processing proceeds to S403.

In S403, the control unit 101 determines whether the tracking has not caught sight of the set user for more than a first time length (for example, five seconds or so) that is a predetermined time. In a case where the tracking does not catch sight of the set user for more than the first time length, the processing proceeds to S404, and in a case where it has not exceeded the first time length, the processing returns to S402.

In S404, when the tracking has not caught sight of the set user for more than the first time length, the control unit 101 determines that the user has been lost, and temporarily stops traveling in accordance with the path that is currently generated. Furthermore, the control unit 101 notifies the set user of the position of the mobile object 100 itself via the speaker 103, makes an utterance to prompt re-authentication, and transitions to a state of conducting the re-authentication. In addition, a predetermined warning sound may be output from the speaker 103, instead of the utterance.

Subsequently, in S405, the control unit 101 determines whether the re-authentication has been conducted successfully. Here, the re-authentication indicates that, for example, the set user inserts its hand into the detection range of the vein sensor 107, and confirms the identity with the vein information that has been already registered in the above S101. In a case where the re-authentication is successful, the processing returns to S401, the driving is resumed, and the tracking is conducted. On the other hand, in a case where the re-authentication is not conducted or in a case where the re-authentication has been conducted but failed, the processing proceeds to S406.

In S406, the control unit 101 determines whether it has exceeded a second time length (for example, five minutes or so) longer than the first time length, since the set user is no longer in sight. In a case where it has not exceeded the second time length, the processing returns to S405. On the other hand, in a case where it has exceeded the second time length, the processing proceeds to S407, and the control unit 101 determines that the set user has been completely lost, moves the mobile object 100 to a predetermined standby place, and ends the processing of the present flowchart.

### Summary of Embodiments

The above embodiments disclose at least the following embodiments.

1. A mobile object (100) in the above embodiment, includes:
a first sensor (108) configured to detect a target object in surroundings;
a setting unit (124) configured to recognize and set a user;
a path generation unit (126) configured to acquire a predicted path indicating a future path of the user that has been set by the setting unit, based on a movement of the user and an output from the first sensor, and configured to generate a path of the mobile object to lead the user on a forward side of the user, based on the predicted path; and
a travel control unit (127) configured to cause the mobile object to travel in accordance with the path that has been generated, in which
upon detection of a change in a moving direction of the user, based on the output from the first sensor, the path generation unit modifies the path to cause the mobile object to move to the forward side of the user in accordance with the moving direction that has been changed (S105, S107).

According to this embodiment, it is possible to provide the mobile object that suitably modifies the path in accordance with the path change that has been made by the user.

2. In the above embodiment, upon detection of at least a predetermined change in the moving direction of the user within a predetermined time, the path generation unit modifies the path (S107, S201).

According to this embodiment, the path of the mobile object can be modified promptly in accordance with the change in the moving direction of the user, and loss of the set user can be reduced.

3. In the above embodiment, the path generation unit acquires a line-of-sight direction of the user, based on the output from the first sensor, and acquires the predicted path with the line-of-sight direction as a direction in which the user will move in the future (S301, S305).

According to this embodiment, the future moving direction of the user can be suitably predicted.

4. In the above embodiment, in a case where the path generation unit is not capable of acquiring the line-of-sight direction of the user, based on the output from the first sensor, the path generation unit acquires the predicted path with a trunk orientation of the user as the direction in which the user will move in the future (S302, S305).

According to this embodiment, even though the line-of-sight direction of the user cannot be acquired, it is possible to estimate the direction in which the user will move in the future and to generate the predicted path.

5. In the above embodiment, the path to be modified, upon detection of the change in the moving direction of the user based on the output from the first sensor, is modified to shorten a distance to the user, as compared with the distance before the detection of the change in the moving direction of the user.

According to this embodiment, the possibility of losing the set user can be reduced.

6. In the above embodiment, the travel control unit causes the mobile object to travel in accordance with the path that has been generated by the path generation unit, tracks the user in accordance with the output from the first sensor, and maintains a distance to the user at a predetermined distance (S106, S401).

According to this embodiment, it is possible to lead the set user suitably, and also to reduce the occurrence of loss of the set user.

7. In the above embodiment, a second sensor (107) configured to conduct vein authentication of the user is further included, in which
the setting unit recognizes and sets the user by use of an output from the second sensor (S101), and
in a case where a track of the user is lost, the travel control unit temporarily stops the mobile object, and in a case where the user that has been set by the setting unit is re-authenticated by the second sensor, the travel control unit resumes driving (S401 to S405).

According to this embodiment, even in a case where the user is temporarily lost, the provision of the service can be suitably resumed.

8. In the above embodiment, a voice output unit configured to make an utterance to prompt re-authentication of the user is further included, in a case where a first time length elapses since the track of the user is lost (S404).

According to this embodiment, even in a case where the user is lost, the possibility of re-authentication by the user can be increased.

9. In the above embodiment, the travel control unit causes the mobile object to move to a predetermined standby position, in a case where a second time length longer than the first time length elapses since the track of the user is lost (S406, S407).

According to this embodiment, in a case where the user is completely lost, it is possible to retreat the mobile object to a predetermined place so as not to obstruct any other passersby or the like.

10. In the above embodiment, a control method for a mobile object (100) including a first sensor (108) configured to detect a target object in surroundings, the control method comprising:
a setting step (S101) of recognizing and setting a user;
a path generation step (S105) of acquiring a predicted path indicating a future path of the user, based on a movement of the user that has been set by the setting step and an output from the first sensor, and generating a path of the mobile object to lead the user on a forward side of the user, based on the predicted path; and
a travel control step (S106) of causing the mobile object to travel in accordance with the path that has been generated, in which
upon detection of a change in a moving direction of the user, based on the output from the first sensor, the path generation step modifies the path to cause the mobile object to move to the forward side of the user in accordance with the moving direction that has been changed (S105, S107).

According to this embodiment, it is possible to provide a method for controlling the mobile object that suitably modifies the path in accordance with the path change that has been made by the user.

The invention is not limited to the foregoing embodiments, and various variations/changes are possible within the spirit of the invention.

What is claimed is:

1. A mobile object comprising:
a first sensor configured to detect a target object in surroundings;
a setting unit configured to recognize and set a user;
a path generation unit configured to acquire a predicted path indicating a future path of the user, based on a movement of the user that has been set by the setting unit and an output from the first sensor, and configured to generate a path of the mobile object to lead the user on a forward side of the user, based on the predicted path; and
a travel control unit configured to cause the mobile object to travel in accordance with the path that has been generated, wherein
upon detection of a change in a moving direction of the user, based on the output from the first sensor, the path generation unit modifies the generated path to cause the mobile object to move to the forward side of the user in accordance with the moving direction that has been changed.

2. The mobile object according to claim 1, wherein upon detection of at least a predetermined change in the moving direction of the user within a predetermined time, the path generation unit modifies the generated path.

3. The mobile object according to claim 1, wherein the path generation unit acquires a line-of-sight direction of the user, based on the output from the first sensor, and acquires the predicted path with the line-of-sight direction as a direction in which the user will move in the future.

4. The mobile object according to claim 3, wherein in a case where the path generation unit is not capable of acquiring the line-of-sight direction of the user, based on the output from the first sensor, the path generation unit acquires the predicted path with a trunk orientation of the user as the direction in which the user will move in the future.

5. The mobile object according to claim 1, wherein the path to be modified, upon detection of the change in the moving direction of the user based on the output from the first sensor, is modified to shorten a distance to the user, as compared with the distance before the detection of the change in the moving direction of the user.

6. The mobile object according to claim 1, wherein the travel control unit causes the mobile object to travel in accordance with the path that has been generated by the path generation unit, tracks the user in accordance with the output from the first sensor, and maintains a distance to the user at a predetermined distance.

7. The mobile object according to claim 6, further comprising
a second sensor configured to conduct vein authentication of the user, wherein
the setting unit recognizes and sets the user by use of an output from the second sensor, and
in a case where track of the user is lost, the travel control unit temporarily stops the mobile object, and in a case where the user that has been set by the setting unit is re-authenticated by the second sensor, the travel control unit resumes driving.

8. The mobile object according to claim 7, further comprising a voice output unit configured to make an utterance to prompt re-authentication of the user, in a case where a first time length elapses since the track of the user is lost.

9. The mobile object according to claim 8, wherein the travel control unit causes the mobile object to move to a predetermined standby position, in a case where a second time length longer than the first time length elapses since the track of the user is lost.

10. A control method for a mobile object including a first sensor configured to detect a target object in surroundings, the control method comprising:
a setting step of recognizing and setting a user;
a path generation step of acquiring a predicted path indicating a future path of the user that has been set in the setting step, based on a movement of the user and an output from the first sensor, and generating a path of the mobile object to lead the user on a forward side of the user, based on the predicted path; and
a travel control step of causing the mobile object to travel in accordance with the path that has been generated, wherein
upon detection of a change in a moving direction of the user, based on the output from the first sensor, the path generation step modifies the generated path to cause the mobile object to move to the forward side of the user in accordance with the moving direction that has been changed.
